(19) United States
(12) Patent Application Publication
(10) Pub. No.: US 2005/0277062 A1
(43) Pub. Date: Dec. 15, 2005

(54) Method of making a photopolymer sleeve blank having an integral UV transparent cushion layer for flexographic printing

(76) Inventors: Michael E. McLean, Etowah, NC (US); Dieter Schulze-Baing, Ahaus-Ottenstein (DE); Michael Kockentiedt, Legden (DE); Stephan Riechert, Frankfurt (DE); Mario Busshoff, Ahaus (DE); Thies Knudsen, Offenbach (DE)

Correspondence Address: DINSMORE & SHOHL LLP;One Dayton Centre, Suite 1300, One South Main Street, Dayton, OH, 45402-2023, US

(21) Appl. No.: 11/124,400

(22) Filed: May 6, 2005

Related U.S. Application Data
(60) Provisional application No. 60/568,978, filed on May 7, 2004.

(51) Int. Cl. G03C 5/00

(52) U.S. Cl. 430/311

(57) ABSTRACT

A method of making a photopolymer sleeve blank for use in flexographic printing is provided which includes providing a base sleeve, applying a cushion layer over the base sleeve which is substantially transparent to curing radiation, applying an optional barrier layer over the cushion layer, and applying a photopolymer layer over the barrier or cushion layer. The inner surface of the base sleeve is then exposed to curing radiation such that the radiation penetrates the sleeve and cushion layer to substantially cure a portion of the thickness of the photopolymer layer.

### CROSS REFERENCE TO RELATED APPLICATIONS

This application claims the benefit of U.S. Provisional Application No. 60/568,978, entitled METHOD OF MAKING A PHOTOPOLYMER SLEEVE BLANK HAVING AN INTEGRAL UV TRANSPARENT CUSHION LAYER FOR FLEXOGRAPHIC PRINTING, filed May 7, 2004. The entire contents of said application are hereby incorporated by reference.

### BACKGROUND OF THE INVENTION

The present invention relates to a method of making a photopolymer sleeve blank, and more particularly, to an improved method of making a photopolymer sleeve for use in flexographic printing applications that may be imaged by an end user.

Flexographic printing plates formed from photopolymerizable compositions are well known for use in printing applications. Such photopolymerizable compositions typically comprise at least an elastomeric binder, a monomer, and a photoinitiator. Upon exposure of the photopolymer plate from the back to actinic radiation, polymerization of the photopolymerizable layer occurs. This step is typically referred to as an initial “back exposure” step in which the polymerized portion of the cross-section of the printing plate is formed, which is referred to as the “floor.” The floor provides a foundation for the creation of a relief image on the plate. After the desired image of the printing plate is formed by exposure to actinic radiation to the portion of the photopolymer above the floor, the unexposed areas of the plate are removed, typically by washing with a solvent, to form a printing relief. However, when using individually attached plates in which the plates are wrapped around a print cylinder or print sleeve, a seam or void interrupts the image, causing a disruption or distortion in the printed image which is transferred to the substrate.

In more recent years, “seamless” hollow cylindrical sleeves have been developed which include a photopolymer layer as a support for various types of printing. For example, in one existing printing process and product (commercially available from OEC Graphics, Inc. under the designation SEAMEX®), a photopolymerizable material in the form of a flat sheet is wrapped around a metal or plastic sleeve and heated to fuse the ends and bond the photopolymerizable material to the sleeve. The photopolymerizable material is subjected to a back exposure step prior to wrapping the sleeve in order to achieve the required floor to support the details in the relief image. However, it is often desirable to product a seamless photopolymer surface including an underlying cushion layer such as a cushioning foam. While the above described process can include such a cushion layer, it is very time consuming and limits the production volume.

In order to achieve high volumes of seamless photopolymer sleeves, no “floor” can be present because disturbances in the seam are created during fusing. These disturbances occur because the floor and the unexposed photopolymer above the floor fuse under different conditions. Therefore, the need for a back exposure step in the above-described process presents problems in the production of blank sleeves.

It would be desirable to be able to produce high volumes of photopolymer sleeves which includes an unexposed photopolymer layer over a cushion layer and which may be easily and effectively back exposed. It would also be desirable to produce a blank photopolymer sleeve which can be readily provided with images by an end user to improve print quality.

Accordingly, there is still a need in the art for an improved method of making a photopolymer print sleeve for use in flexographic printing operations.

### SUMMARY OF THE INVENTION

Embodiments of the present invention meet that need by providing a photopolymer sleeve which includes a cushion layer which is integral with the sleeve and which may be easily cured. The present invention further provides a blank photopolymer sleeve that can be readily imaged by an end user to enhance print quality.

According to one aspect of the present invention, a method of making a photopolymer sleeve blank is provided comprising providing a cylindrical base sleeve having an inner surface and an outer surface, and applying a cushion layer over the outer surface of the base sleeve, where the cushion layer is substantially transparent to curing radiation. By “curing radiation,” it is meant those wavelengths of radiation which initiate polymerization of the photopolymer. By substantially transparent, it is meant that at least 20% of incident radiation passes through the cushion layer. The method further includes applying a photopolymer layer over the cushion layer, and exposing the inner surface of the base sleeve to curing radiation such that the radiation penetrates the sleeve to substantially cure a portion of the thickness of the photopolymer layer adjacent the cushion layer.

Preferably, the base sleeve is selected from the group consisting of a fiber-reinforced polymeric resin or plastic. The base sleeve preferably has a thickness between about 0.01 and about 6.35 mm, and more preferably, between about 0.60 and 0.80 mm.

The cushion layer is preferably selected from the group consisting of an open cell foam, a closed cell foam, or a volume displaceable material. The cushion layer preferably has a thickness of between about 0.25 and 3.25 mm. and more preferably, between about 1.0 and 1.5 mm. The cushion layer is preferably applied to the base sleeve by rotary casting, extrusion, or blade or knife coating. Alternatively, the cushion layer may be in the form of a sheet and applied to the base sleeve with an adhesive. Preferably, after the cushion layer is applied, the surface of the cushion layer is ground to achieve a predetermined thickness. The cushion layer preferably transmits from about 20% to about 80% of incident UV light in the range of from about 300 nm to about 425 nm.

After application of the cushion layer, the photopolymer layer is applied over the cushion layer. The photopolymer layer preferably comprises a styrenic block copolymer based material. The photopolymer is preferably laminated to the cushion layer by the application of an optional sealant or adhesion promoting agent. The photopolymer layer is then preferably fused to the surface of the cushion layer by the application of heat. The photopolymer layer is preferably ground to a predetermined thickness, either after the application of the photopolymer layer or after exposing the inner surface of the base sleeve to radiation. The photopolymer layer preferably has a thickness of between about 1.0 and 1.5 mm.

The inner surface of the base sleeve is then exposed to curing radiation such that the radiation penetrates the layers in the sleeve to cure the desired thickness of the photopolymer layer and form a “floor.” Typically, such curing radiation will comprise UV radiation. Because the cushion layer is formed from a material that is transparent to such radiation, the sleeve may be cured from the interior using a conventional “back exposure” step. This saves time in preparation of the photopolymer, reduces waste, and gives the image processor the option to vary the relief depth of the image, enhancing print quality.

Preferably, the method also includes coating the photopolymer layer with an ablatable coating. The ablatable coating functions to protect the photopolymer layer from UV light, thus preventing curing of the uncured photopolymer layer (above the floor) prior to use.

In an alternative embodiment of the invention, the method includes applying a barrier layer between the cushion layer and the photopolymer layer, i.e., the barrier layer is applied over the cushion layer and the photopolymer layer is applied over the barrier layer. The barrier layer preferably comprises a film-forming polymer, such as an acrylic resin or polyvinylidene chloride. Preferably, the barrier layer has a thickness of between about 0.015 and 0.050 mm, and more preferably, about 0.25 mm. The photopolymer layer is preferably laminated to the barrier layer and then fused to the barrier layer by the application of heat.

The resulting sleeve blank containing the (uncured) photopolymer layer may be imaged and processed by conventional equipment used in the art.

Accordingly, it is a feature of the present invention to provide a photopolymer sleeve blank including an integral radiation transparent cushion layer for use in flexographic printing applications. Other features and advantages of the invention will be apparent from the following description, the accompanying drawings, and the appended claims.

### BRIEF DESCRIPTION OF THE DRAWINGS

FIG. 1 is a cross-sectional view of a photopolymer sleeve blank according to an embodiment of the present invention; and

FIG. 2 is a flow chart illustrating the method of making the photopolymer sleeve blank in accordance with an embodiment of the present invention.

### DETAILED DESCRIPTION OF THE PREFERRED EMBODIMENTS

The practice of embodiments of the present invention provide several advantages over prior art methods which include cushion layers. By using a radiation transparent cushion layer, the floor of the photopolymer layer may be hardened using a “back exposure” step as in conventional methods. In addition, by providing a blank sleeve for use by an end user, the end user can vary the depth of the relief image to provide higher print quality results.

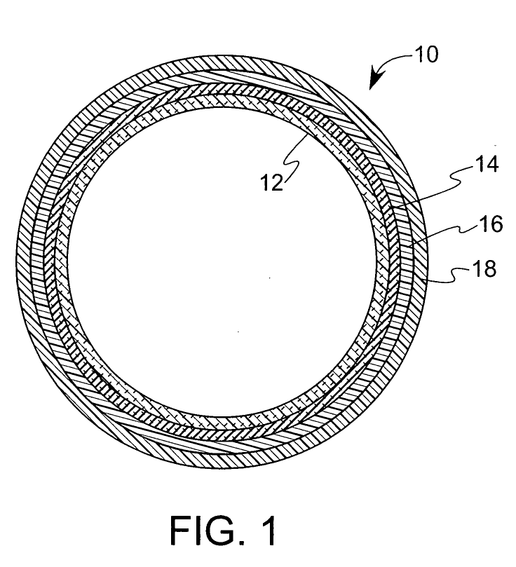

FIG. 1 illustrates one embodiment of the photopolymer sleeve blank 10 having a seamless surface which comprises a base sleeve 12, a cushion layer 14, an optional barrier layer 16, and a photopolymer layer 18. The base sleeve 12 is a thin-walled hollow cylindrical sleeve which preferably comprises a fiber-reinforced polymer resin having a wall thickness of from between about 0.01 and 6.35 mm, and more preferably, between about 0.60 and 0.80 mm. One example of a base sleeve construction that may be used in the present invention is described in commonly-assigned U.S. Pat. No. 6,703,095. The cylindrical base is expandable under the application of fluid pressure and provides a fluid-tight seal when the sleeve is mounted onto a cylinder, mandrel, or the like.

Cushion layer 14 is applied over base sleeve 12 as shown in FIG. 1. Preferably, the cushion layer has a thickness of from between about 0.25 and 3.25 mm, and more preferably, between about 1.0 to 1.50 mm. The cushion layer may comprise an open or closed cell foam or a soft, displaceable material. The cushion layer is preferably transparent to UV radiation at at least those wavelengths that initiate polymerization of the photopolymer layer and is formulated from components that transmit such radiation. Preferred for use are aliphatic polyurethanes. The preferred transmission of UV light is from about 20% up to about 80%, however, it should be appreciated that the degree of transmission may vary. The transparency is controlled by the combination of the materials chosen, the thickness of the layer, and the degree and size of any voids.

As shown in FIG. 1, an optional barrier layer 16 is applied over the cushion layer. The barrier layer should also be transparent to UV radiation and preferably comprises a film forming acrylic resin or polyvinylidene chloride and has a thickness of between about 0.015 mm and 0.050 mm, and more preferably, about 0.025 mm (about 1 mil).

A photopolymer layer 18 is applied over barrier layer 16 to form an integral sleeve. The photopolymer layer preferably comprises a styrenic block copolymer based material such as Dupont Cyrel® HORB or MacDermid SP6.0. The photopolymer layer 18 preferably has a thickness of from between about 1.0 and 1.50 mm.

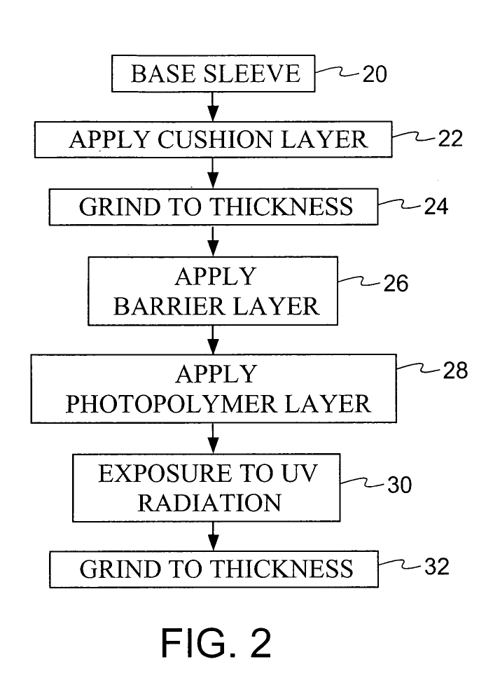

The flowchart of FIG. 2 depicts a general representation of the steps used to produce the photopolymer sleeve blank in accordance with an embodiment of the present invention. In step 20, the base sleeve is provided, and in step 22, the cushion layer is applied to the base sleeve. The cushion layer is preferably applied to the base sleeve by rotary casting, extrusion, or blade or knife coating. In step 24, the cushion layer is ground to the desired thickness by methods known in the art such as, for example, stone grinding.

In step 26, an optional thin barrier layer is applied over the cushion layer, preferably by knife coating. The barrier layer preferably has a thickness of from about 0.001 inches to 0.010 inches (0.002 to 0.025 cm). An optional UV transmitting adhesive agent may be applied between the layers. The barrier layer is preferably applied to the cushion layer such that any heat generated during the fusing of the photopolymer layer to the barrier layer does not cause any undesirable side effects such as delamination or creation of bubbles in or to the unexposed photopolymer layer. In addition, the barrier layer should have sufficient adhesion to the cushion layer and the unexposed photopolymer layer so that the unexposed photopolymer layer can withstand all process steps including use on a flexographic or gravure printing press in desired customer applications.

In step 28, the photopolymer layer is in the form of a sheet applied over the barrier layer. The photopolymer layer is preferably laminated to the barrier layer by applying a thin sealer or adhesive promoting agent to the surface of the barrier layer. The photopolymer layer is then fused to the barrier layer by the application of heat in a manner sufficient to partially melt the photopolymer such that any seams flow together and are substantially eliminated. Preferably, the photopolymer layer is fused by the application of infrared heat. The photopolymer surface may then be ground to a desired wall thickness (step 32) by conventional methods such as stone grinding.

In step 30, a “floor” is created by a back exposing step in which radiation is transmitted through the base, cushion layer, and barrier layer to “back expose” the floor in the unexposed photopolymer layer. The radiation source is preferably in the form of a linear light source such as a bulb or tube that is positioned interior to the base sleeve. Typically, the radiation source will be a source of UV radiation in the range of from about 300 nm to about 425 nm. After curing, the photopolymer surface is preferably ground by conventional methods (step 32) to a desired thickness such that the floor is precisely established.

After grinding the photopolymer layer, the sleeve is preferably cleaned and the surface is coated with a thin layer of an ablatable coating, such as a LAMS coating.

The resulting sleeve comprises a ready-to-image sleeve blank including an integral cushion layer that can be imaged and processed in a tubular manner using conventional equipment. The outer surface of the photopolymer layer of the sleeve may be imaged as is known in the art to provide a raised relief surface or depressions for flexographic and/or gravure printing. For example, the photopolymer layer may be imaged by actinic radiation, by mechanical grinding, or by laser ablation to form an imaged relief surface. The resulting sleeve provides high print quality.

Having described the invention in detail and by reference to preferred embodiments thereof, it will be apparent that modifications and variations are possible without departing from the scope of the invention.

1. A method of making a photopolymer sleeve blank for use in flexographic printing comprising:
providing a cylindrical base sleeve including an inner surface and an outer surface;
applying a cushion layer over said outer surface of said base sleeve; said cushion layer being substantially transparent to curing radiation;
applying a photopolymer layer over said cushion layer; and
exposing the inner surface of said base sleeve to curing radiation; wherein said radiation penetrates the sleeve to substantially cure a portion of the thickness of said photopolymer layer adjacent said cushion layer.

2. The method of claim 1 wherein said base sleeve is selected from the group consisting of a fiber-reinforced polymeric resin or plastic.

3. The method of claim 1 wherein said base sleeve has a thickness between about 0.01 and about 6.35 mm.

4. The method of claim 1 wherein said base sleeve has a thickness between about 0.60 and about 0.80 mm.

5. The method of claim 1 wherein said cushion layer is selected from the group consisting of an open cell foam, a closed cell foam, or a volume displaceable material.

6. The method of claim 1 wherein said radiation comprises UV radiation.

7. The method of claim 6 wherein said cushion layer transmits from about 20% to about 80% of incident UV light in the range of from about 300 nm to about 425 nm.

8. The method of claim 1 wherein said cushion layer has a thickness of between about 0.25 and about 3.25 mm.

9. The method of claim 1 wherein said cushion layer has a thickness of between about 1.0 and about 1.50 mm.

10. The method of claim 1 wherein said cushion layer is applied to said base sleeve by rotary casting, extrusion, or blade or knife coating.

11. The method of claim 1 wherein said cushion layer is applied to said base sleeve with an adhesive.

12. The method of claim 1 including grinding the surface of said cushion layer to achieve a predetermined thickness after applying said cushion layer.

13. The method of claim 1 wherein said photopolymer layer comprises a styrenic block copolymer-based material.

14. The method of claim 1 including laminating said photopolymer layer to said cushion layer.

15. The method of claim 1 including fusing said photopolymer to the surface of said cushion layer by the application of heat.

16. The method of claim 1 including grinding the surface of said photopolymer layer to achieve a predetermined thickness after applying said photopolymer layer.

17. The method of claim 1 including grinding the surface of said photopolymer layer to achieve a predetermined thickness after exposing said inner surface of said base sleeve to radiation.

18. The method of claim 1 wherein said photopolymer layer has a thickness of between about 1.0 and about 1.5 mm.

19. The method of claim 1 including coating said photopolymer layer with an ablatable coating.

20. The method of claim 1 wherein the portion of said photopolymer layer which is cured has a thickness of from about 0.005 inches to about 0.050 inches.

21. The method of claim 1 including forming an image on said photopolymer sleeve blank.

22. A seamless photopolymer sleeve blank formed by the method of claim 1.

23. A method of making a photopolymer sleeve blank for use in flexographic printing comprising:
providing a cylindrical base sleeve including an inner surface and an outer surface;
applying a cushion layer over said outer surface of said base sleeve; said cushion layer being substantially transparent to curing radiation;
applying a barrier layer over said cushion layer;
applying a photopolymer layer over said barrier layer; and
exposing the inner surface of said base sleeve to curing radiation; wherein said radiation penetrates said sleeve to substantially cure a portion of the thickness of said photopolymer layer.

24. The method of claim 23 wherein said barrier layer comprises a film-forming polymer.

25. The method of claim 23 wherein said barrier layer comprises an acrylic resin or polyvinylidene chloride.

26. The method of claim 23 wherein said barrier layer has a thickness of between about 0.015 and about 0.050 mm.

27. The method of claim 23 wherein said barrier layer has a thickness of about 0.25 mm.

28. The method of claim 23 wherein said base sleeve is selected from the group consisting of a fiber-reinforced polymeric resin or plastic.

29. The method of claim 23 wherein said cushion layer is selected from the group consisting of an open cell foam, a closed cell foam, or a volume displaceable material.

30. The method of claim 23 wherein radiation comprises UV radiation and wherein said cushion layer transmits from about 20% to about 80% of incident UV light in the range of from about 300 nm to about 425 nm.

31. The method of claim 23 wherein said photopolymer layer comprises a styrenic block copolymer-based material.

32. The method of claim 23 including laminating said photopolymer layer to said barrier layer.

33. The method of claim 23 including fusing said photopolymer layer to the surface of said barrier layer by the application of heat.

34. The method of claim 1 including forming an image on said photopolymer sleeve blank.
